(19) United States
(12) Patent Application Publication
(10) Pub. No.: US 2014/0052488 A1
(43) Pub. Date: Feb. 20, 2014

(54) CONTEXTUAL TASK MANAGEMENT AND NOTIFICATIONS

(71) Applicants: Kevin A. MINDER, Medford, NJ (US); Robyn J. Chan, San Francisco, CA (US); Hanju Kim, Palo Alto, CA (US)

(72) Inventors: Kevin A. MINDER, Medford, NJ (US); Robyn J. Chan, San Francisco, CA (US); Hanju Kim, Palo Alto, CA (US)

(73) Assignee: Magnet Systems, Inc., Palo Alto, CA (US)

(21) Appl. No.: 13/586,747

(22) Filed: Aug. 15, 2012

(51) Int. Cl. G06Q 10/06

(52) U.S. Cl. 705/7.15; 705/7.27

(57) ABSTRACT

Systems and processes for presenting event notifications to a target user based on the context of the user are disclosed. The event notification can be selectively presented to the target user based on a comparison between the event and the context of the user. If the event and the context of the user meet predefined criteria, the event notification can be presented to the target user. If the event and the context of the user do not meet the predefined criteria, the event notification may be stored for later delivery to the target user.

### BACKGROUND

1. Field

The present disclosure relates to notifications for task management applications and, in one particular example, to contextual notifications for task management applications.

2. Related Art

Task management applications are often used to schedule and track various tasks within a workflow. Many of these applications include a notification feature that automatically notifies a user upon the occurrence of an event of interest, such as a new task assignment, a message from a coworker, or the like. Typically, the application will immediately notify the user upon detection of the relevant event. While these conventional notification features provide the user with up-to-date information, notifications received at the wrong time may result in reduced productivity.

Some more sophisticated task management applications may include alert management features that deliver some notifications while storing others to be delivered at a later time. These applications, however, typically decide which notifications to deliver and which notifications to store based on a priority value assigned to the event by the user issuing the event. Thus, while conventional alert management features may filter the notifications sent to the user, notifications may still be presented to the user at inconvenient times.

### SUMMARY

Processes for notifying a target user of an event are described. The process may include receiving event data associated with the event, receiving workflow data associated with an active workflow of the target user, comparing the event data with the workflow data, and selectively presenting a notification to the target user based at least in part on the comparing of the event data with the workflow data. Comparing the event data with the workflow data may include comparing a workflow of the event with the active workflow of the user. In some examples, selectively presenting the notification to the target user may include presenting, in response to a match being identified by the comparing the event data with the workflow data, the notification to the target user. In some examples, the event comprises a new task to be completed by the target user.

In some examples, comparing the event data with the workflow data may include comparing an issuing user of the event with the active workflow of the user. In other examples, selectively presenting the notification to the target user may include presenting, in response to a match being identified by the comparing the event data with the workflow data, the notification to the target user.

In some examples, the process may further include generating, based on the event data, a set of event data keywords associated with the event data, and comparing the set of event data keywords with a set of active workflow keywords associated with the active workflow of the user. Selectively presenting the notification to the target user may include presenting, in response to a match being identified by the comparing the set of event data keywords with the set of active workflow keywords, the notification to the target user.

Apparatus and non-transitory computer-readable storage media for notifying a target user of an event are also described.

### BRIEF DESCRIPTION OF THE FIGURES

The present application can be best understood by reference to the following description taken in conjunction with the accompanying drawing figures, in which like parts may be referred to by like numerals.

FIG. 1 illustrates an exemplary system for carrying out certain aspects and examples of the embodiments described herein.

FIG. 2 illustrates an exemplary process for presenting a notification to a user.

FIG. 3 illustrates another exemplary process for presenting a notification to a user.

FIG. 4 illustrates an exemplary computing system that may be used to carry out the various embodiments described herein.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the present technology. Thus, the disclosed technology is not intended to be limited to the examples described herein and shown, but is to be accorded the scope consistent with the claims.

Various embodiments are described below relating to systems and processes for presenting event notifications to a target user based on the context of the user (e.g., the environment, function being performed, etc., of the user). The event notification can be selectively presented to the target user based on a comparison between the event and the context of the user. If the event and the context of the user meet predefined criteria, the event notification can be presented to the target user. If the event and the context of the user do not meet the predefined criteria, the event notification may be stored for later delivery to the target user. In one particular example, the disclosed notification systems and processes can be applied to a task management application that schedules and tracks various tasks within a workflow. As used herein, a “workflow” may refer to a series of tasks that are grouped together to accomplish a larger objective. In this example, an event notification for a new task being assigned to a target user can be selectively presented to the target user based on a comparison between the new task and an active workflow being performed by the target user. While the notification systems and processes are described below with respect to a task management application, it should be appreciated that the principles described herein can similarly be used in other applications and environments.

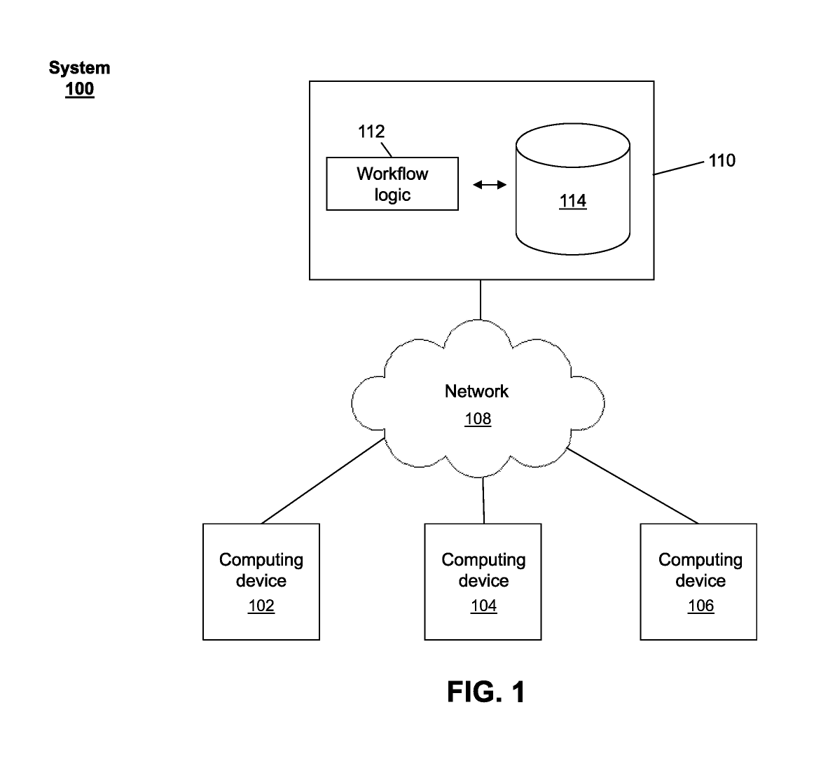

FIG. 1 illustrates an exemplary system 100 for carrying out certain aspects and examples of the embodiments described herein. Generally, system 100 may include computing devices 102, 104, and 106 that may communicate with each other and/or server 110 via network 108. Server 110 and computing devices 102, 104, and 106 may include any one of various types of computer devices having, for example, a processing unit, a memory (including a permanent storage device), and a communication interface, as well as other conventional computer components (e.g., an input device, such as a keyboard and mouse, and an output device, such as display). For example, computing devices 102, 104, and 106 may include any type of computing device, such as a mobile phone, laptop, tablet, desktop computer, or the like. Each computing device 102, 104, and 106 may include a workflow application for tracking past, current, and future workflows associated with a user of the computing device. In some examples, as described in greater detail below, the workflow application may be operable to selectively present notifications to the user of the computing device based on a context of the user. While three computing devices are shown, it should be appreciated that system 100 may include any number of computing devices.

Server 110 and computing devices 102, 104, and 106 may communicate, for example, using suitable communication interfaces via network 108, such as the Internet, a LAN, a WAN, or the like. Server 110 and computing devices 102, 104, and 106 may communicate, in part or in whole, via wireless or hardwired communications, such as Ethernet, IEEE 802.11a/b/g/n/ac wireless, or the like. Additionally, communication between computing devices 102, 104, and 106 and server 106 may include various servers, such as a mobile server or the like.

Server 110 may include or access workflow logic 112 and database 114. In one example, database 114 may store task data and workflow data associated with tasks and workflows assigned to users of computing devices 102, 104, and 106. In one example, the task data may include one or more of text associated with the task (e.g., a text description of the task to be completed), identity of an issuer of the task, document(s) associated with the task, identifier of an associated workflow, target user assigned to the task, or the like. In one example, the workflow data may include one or more of an identifier of the workflow, task(s) associated with the workflow, owner of the workflow, and the like.

In one example, workflow logic 112 may be used to track tasks and workflows assigned to users associated with computing devices 102, 104, and 106. For example, a user associated with computing device 102 may want to assign a task to a user associated with computing device 104. To do so, the user of computing device 102 may send task data associated with the task to server 110 via network 108. Workflow logic 112 may be used to process the task assignment by storing the task data within database 114 and forwarding the task data to computing device 104 via network 108. Additionally, workflow logic 112 can be used to receive workflow data associated with a particular user. For example, a user of computing device 106 may want send a request to server 110 via network 108 to receive workflow data associated with the user. Workflow logic 112 can access database 114 to retrieve workflow data associated with the user (e.g., by using a username/password) and may transmit the retrieved workflow data to computing device 106 via network 108.

Server 110 may be further programmed to format data, accessed from local or remote databases or other sources of data, for presentation to users of computing devices 102, 104, and 106, preferably in the format discussed in detail herein. Server 110 may utilize various Web data interface techniques such as Common Gateway Interface (CGI) protocol and associated applications (or “scripts”), Java® “servlets”, i.e., Java applications running on the Web server, an application that utilizes Software Development Kit Application Programming Interfaces (“SDK APIs”), or the like to present information and receive input from computing devices 102, 104, and 106. Server 110, although described herein in the singular, may actually include multiple computers, devices, backends, and the like, communicating (wired and/or wirelessly) and cooperating to perform the functions described herein.

It will be recognized that, in some examples, individually shown devices may comprise multiple devices and be distributed over multiple locations. Further, various additional servers and devices may be included such as web servers, media servers, mail servers, mobile servers, advertisement servers, and the like as will be appreciated by those of ordinary skill in the art.

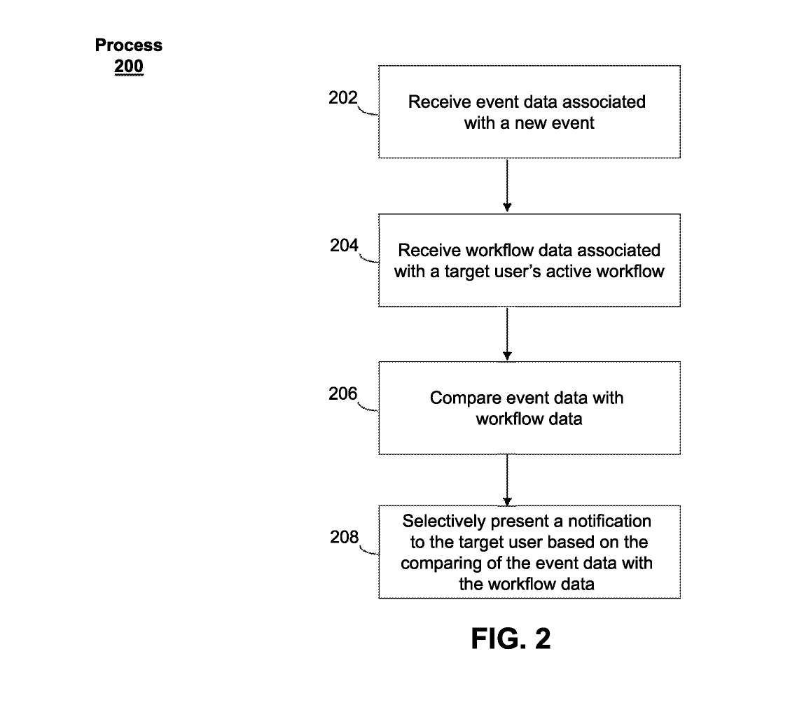

FIG. 2 illustrates an exemplary process 200 for presenting a notification to a user. At block 202, event data associated with a new event may be received. In some examples, the new event may include a new task assigned to a target user. In these examples, the event data may include task data having one or more of text associated with the task (e.g., a text description of the task to be completed), identity of an issuer of the task, document(s) associated with the task, identifier of an associated workflow, target user assigned to the task, or the like. For example, an issuing user associated with a computing device similar or identical to computing devices 102, 104, or 106 may assign a new task to a target user associated with another computing device similar or identical to computing device 102, 104, or 106 by transmitting task data to a server similar or identical to server 110. The server may process the new task as described above and may forward the task data to the target user. The target user may receive the task data from the server and a task management application running on the target user's computing device may store the task data in a memory of the computing system.

At block 204, workflow data associated with a target user's active workflow may be received. The active workflow(s) may represent the workflow currently being performed by the target user. In some examples, the workflow data may include one or more an identifier of the workflow, task(s) associated with the workflow, owner of the workflow, and the like. For example, the application running on the target user's computing device may receive workflow data associated with the target user from a memory within the computing device or may receive the workflow data from a remote location, such as a server similar or identical to server 110.

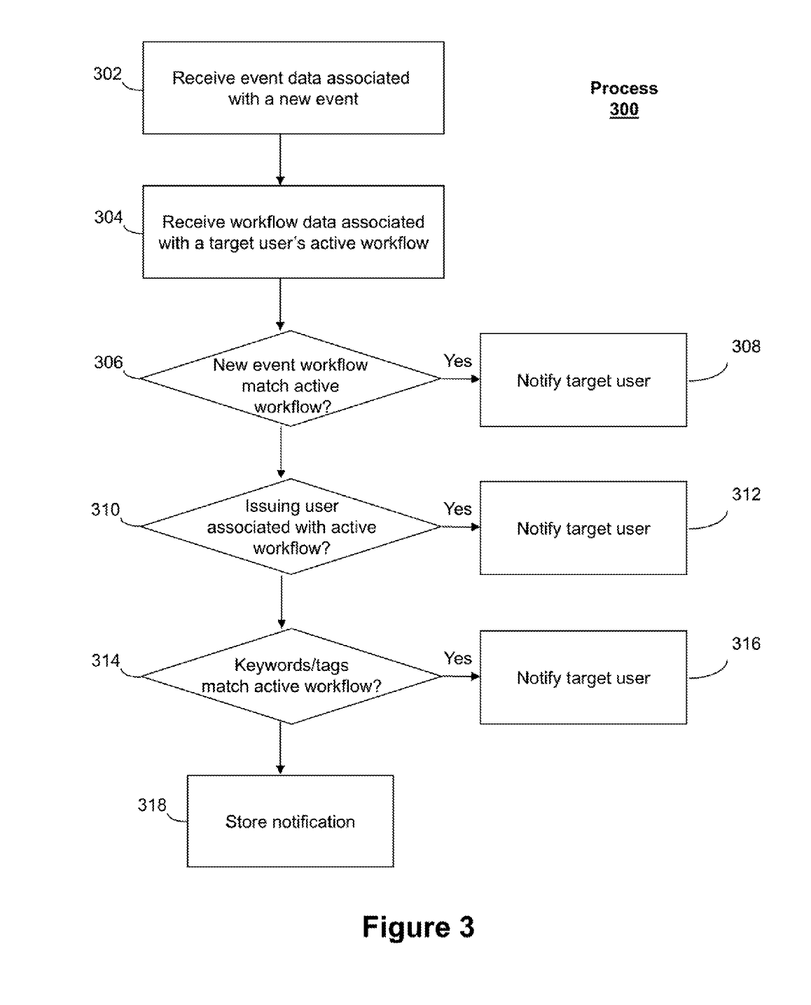

At block 206, the event data (e.g., the task data) received at block 202 may be compared with the workflow data received at block 204. For example, the application running on the target user's computing device may compare the task data associated with the new task with the workflow data associated with the target user's active workflow. The computing device can compare the task data with the workflow data using any known comparison algorithm to determine how related the task data is to the workflow data. Specific comparison algorithms are provided below with respect to FIG. 3. However, it should be appreciated that other algorithms can be used.

At block 208, a notification can be selectively presented to the target user based on the comparison performed at block 206. For example, the application running on the target user's computing device may present a visual and/or audio alert to the target user. The notification may indicate to the user that a potentially relevant event has occurred. The visual and/or audio alert can include any known visual and/or audio notification indicators, such as a chime, a text box containing a brief description of the event, an email, and the like. In some examples, the application running on the target user's computing device can present the notification to the target user when the comparison performed at block 206 indicates that the task data and the workflow data meet threshold relatedness criteria. If, however, the comparison performed at block 206 indicates that the task data and the workflow data does not meet the threshold relatedness criteria, the application may store the notification in the memory of the target user's computing device to be presented to the target user at a later time. For example, the notification can be presented to the target user after the target user completes or halts work on the active workflow, at predetermined intervals, at a predetermined time, in response to a request from the target user, or at another desired time. In this way, the target user may be interrupted by the notification only when the event associated with the notification is sufficiently related to the context of the user (e.g., the function being performed by the target user). This can improve the productivity of the target user by reducing the number of unrelated interruptions experienced by the target user.

In some examples, once it is determined that a notification should be presented to the target user, the delivery method of the notification can be selected based on information related to the context of target user, such as the target user's computing device, location, activity, status, and the like. For example, if the target user is interacting with a workflow using a mobile phone, the notification can be sent in the form of a push notification or an SMS. Alternatively, if the target user is interacting with the workflow using a desktop computer, the notification can be sent to the user in the form of an application event or instant message. Information related to the context of the user can be received before or after it is determined that a notification should be presented to the target user. For example, information related to the context of the user can be received at block 204 along with the workflow data. Alternatively, the information related to the context of the user can be received after it is determined that a notification should be presented to the target user at block 208.

FIG. 3 illustrates another exemplary process 300 for presenting a notification to a user. Process 300 may include blocks 302 and 304, which may be similar or identical to blocks 202 and 204 of process 200. Process 300 may further include blocks 306, 310, and 314, which represent an example implementation of block 206 of process 200. Process 300 may further include blocks 308, 312, 316, and 318, which represent an example implementation of block 208 of process 200.

At block 302, event data associated with a new event may be received in a manner similar or identical to that described above with respect to block 202 of process 200. At block 304, workflow data associated with a target user's active workflow may be received in a manner similar or identical to that described above with respect to block 204, described above.

At block 306, event data associated with the new event received at block 302 may be compared with workflow data associated with the target user's active workflow received at block 304. In some examples, the event data (e.g., task data) associated with the new event (e.g., new task) may be compared with the workflow data associated with the target user's active workflow to determine if a workflow associated with the new event matches the target user's active workflow. For example, the event data associated with the new task may include a workflow identifier representing the workflow that the new task is included within or is intended to be included within. An application running on a computing device similar or identical to computing device 102, 104, or 106 and associated with the target user may compare the new task workflow identifier with the workflow identifier of the target user's active workflow. If the identifiers are the same (or otherwise represent the same workflow), then it can be determined that a match exists between the workflow associated with the new task and the target user's active workflow.

If, at block 306, it is determined that there is a match between the event data associated with the new event received at block 302 and the workflow data associated with the target user's active workflow received at block 304, it can be determined that the new event is relevant to the target user's active workflow and is likely of interest to the target user. As such, the process may proceed to block 308. At block 308, a notification may be presented to the target user. For example, the application running on the target user's computing device may cause a display and/or audio indicator to be presented to the target user. The notification can include any type of notification, such as an email, text message, instant message, noise, or the like. In some examples, the delivery method or type of notification can be selected based on a user preference, context of the user (e.g., as described above with respect to FIG. 2), or the like. In some examples, the notification may also be presented to the target user within a specific computing environment. For example, the notification may be presented to the target user in a portal associated with the active workflow of the target user.

If, however, at block 306, it is determined that there is no match between the event data associated with the new event received at block 302 and the workflow data associated with the target user's active workflow received at block 304, the process may proceed to block 310. At block 310, it can be determined if there is a match between an issuer of the new event and the target user's active workflow. In some examples, the event data received at block 302 may include an identifier of the issuer of the new event and the workflow data received at block 304 may include identifiers of users associated with the target user's active workflow (e.g., users performing portions of the workflow, managing the workflow, and the like). In these examples, an application running on the target user's computing device can compare the issuer identifier with the user identifiers associated with the target user's active workflow. If the issuer identifier is the same as an identifier from the user identifiers associated with the target user's active workflow (or otherwise represent the same user), then it can be determined that a match exists between the issuer of the new event and the target user's active workflow.

If, at block 310, it is determined that there is a match between the issuer of the new event and the target user's active workflow, it can be determined that the issuer of the new event is related to the target user's active workflow and is likely assigning an event that is of interest to the target user. As such, the process may proceed to block 312. At block 312, a notification may be presented to the target user. For example, the application running on the target user's computing device may cause a display and/or audio indicator to be presented to the target user. The notification can include any type of notification, such as an email, text message, instant message, noise, or the like. In some examples, the delivery method or type of notification can be selected based on a user preference, context of the user (e.g., as described above with respect to FIG. 2), or the like. In some examples, the notification may also be presented to the target user within a specific computing environment. For example, unlike at block 308, if a match is detected between the issuing user and a user associated with more than one of target user's active workflows, then the notification may be a general notification that is not limited to a particular portal of the task management application. However, if a match is detected between the issuing user and a user associated with only one of target user's active workflows, then the notification may be limited to a portal associated with that particular workflow.

If, however, at block 310, it is determined that there is no match between the issuer of the new event and the target user's active workflow, the process may proceed to block 314. At block 314, it can be determined if there is a match between keywords or tags associated with the new event and keywords or tags associated with the target user's active workflow. In some examples, at block 314 (or, alternatively, at any block preceding block 314), one or more information retrieval techniques can be used to extract keywords from event data (e.g., text and/or documents) associated with the new event received at block 302. Any information retrieval technique known to those of ordinary skill in the art can be used. For example, the application running on the target user's computing device may use an information retrieval technique, such as KEA (available at http://www.nzdl.org/KEA) or Apache Tika (available at http://tika.apache.org), to extract keywords from text and/or documents associated with the new event. The extracted keywords may be stored in a memory of the computing device and/or may be transmitted to a server similar or identical to server 110 to be stored in a remote database similar or identical to database 114. Similarly user-assigned tags may also be associated with tasks and workflows. These extracted keywords and assigned tags associated with the new event can be compared to keywords or tags associated with the target user's active workflow. The keywords or tags associated with the target user's active workflow can be generated in a manner similar to that of the new task and can be stored in a memory of the computing device or stored remotely in a database similar or identical to database 114.

In some examples, to determine if there is a match between keywords or tags of the new event and keywords or tags of the target user's workflow, a threshold percentage or number of matching keywords or tags can be used. For example, a match can occur when a threshold percentage or number of the keywords or tags associated with the new task match the keywords or tags of the target user's active workflow. In some examples, the keywords or tags associated with the new event are said to match when they are identical to the keywords or tags of the target user's active workflow. In other examples, the keywords or tags associated with the new event are said to match when they are identical or similar (e.g., variations, synonyms, and the like) to the keywords or tags of the target user's active workflow. The threshold percentage or number can be set to any value depending on the desired level of relatedness between the new event and the target user's active workflow, the total number of keywords or tags, and the like. While specific matching techniques are provided above, it should be appreciated that any other technique can be used to determine a desired level of matching between keywords or tags.

If, at block 314, it is determined that there is a match between the keywords or tags of the new event and the keywords or tags of the target user's active workflow, it can be determined that the new event is potentially related to the target user's active workflow and is likely to be of interest to the target user. As such, the process may proceed to block 316. At block 316, a notification may be sent to the target user in a manner similar or identical to that of block 312, described above.

If, however, at block 314, it is determined that there is no match between the keywords or tags of the new event and the keywords or tags of the target user's active workflow, the process may proceed to block 318. At block 318, a notification can be stored for later delivery to the target user. The notification can be stored in a memory of the target user's computing device and/or can be stored remotely at a server similar or identical to server 110 and can be presented to the target user at a later time. For example, the application running on the target user's computing device may present the notification to the target user in response to the target user completing or halting work on the active workflow, at predetermined intervals, at a predetermined time, in response to a request from the target user, or at another desired time. The time at which the delayed notification is presented to the target user may be predetermined or may be configured by the target user.

While the blocks of process 300 are shown in a particular order, it should be appreciated that the blocks may be performed in a different order. For example, block 306 (and accordingly, block 308) can be performed before or after blocks 310 and 314, block 310 (and accordingly, block 312) can be performed before or after blocks 306 and 314, or block 314 (and accordingly, block 316) can be performed before or after blocks 306 and 310. Additionally, some blocks may not be performed. For example, any of blocks 306 and 308, blocks 310 and 312, or blocks 314 and 316 may not be performed.

Additionally, while the examples provided above describe an application running on a computing device of a user, it should be appreciated that the application's functionality can alternatively be performed on a server similar or identical to server 110 and the results simply displayed on the computing device in a browser or the like.

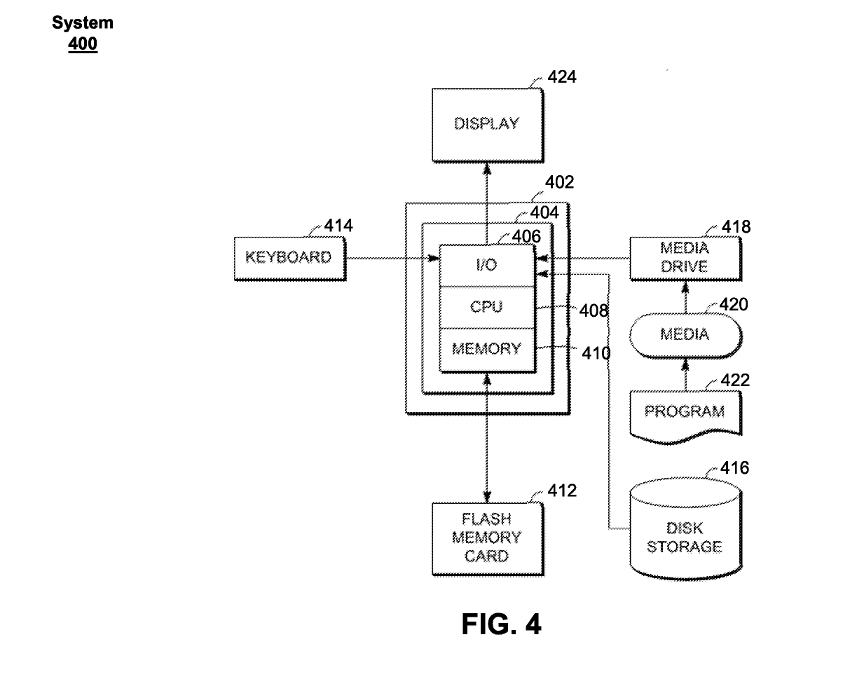

FIG. 4 depicts an exemplary computing system 400 configured to perform any one of the above-described processes. In this context, computing system 400 may include, for example, a processor, memory, storage, and input/output devices (e.g., monitor, keyboard, disk drive, Internet connection, etc.). However, computing system 400 may include circuitry or other specialized hardware for carrying out some or all aspects of the processes. In some operational settings, computing system 400 may be configured as a system that includes one or more units, each of which is configured to carry out some aspects of the processes either in software, hardware, or some combination thereof.

FIG. 4 depicts computing system 400 with a number of components that may be used to perform the above-described processes. The main system 402 includes a motherboard 404 having an input/output (“I/O”) section 406, one or more central processing units (“CPU”) 408, and a memory section 410, which may have a flash memory card 412 related to it. The I/O section 406 is connected to a display 424, a keyboard 414, a disk storage unit 416, and a media drive unit 418. The media drive unit 418 can read/write a computer-readable medium 420, which can contain programs 422 and/or data.

At least some values based on the results of the above-described processes can be saved for subsequent use. Additionally, a non-transitory computer-readable medium can be used to store (e.g., tangibly embody) one or more computer programs for performing any one of the above-described processes by means of a computer. The computer program may be written, for example, in a general-purpose programming language (e.g., Pascal, C, C++, Java) or some specialized application-specific language.

Although only certain exemplary embodiments have been described in detail above, those skilled in the art will readily appreciate that many modifications are possible in the exemplary embodiments without materially departing from the novel teachings and advantages of the present disclosure. For example, aspects of embodiments disclosed above can be combined in other combinations to form additional embodiments. Accordingly, all such modifications are intended to be included within the scope of the present disclosure.

What is claimed is:

1. A computer-implemented method for notifying a target user of an event, the method comprising:
receiving event data associated with the event;
receiving workflow data associated with an active workflow of the target user;
comparing the event data with the workflow data; and
selectively presenting a notification to the target user based at least in part on the comparing of the event data with the workflow data.

2. The computer-implemented method of claim 1, wherein comparing the event data with the workflow data comprises comparing a workflow of the event with the active workflow of the user.

3. The computer-implemented method of claim 2, wherein selectively presenting the notification to the target user comprises presenting, in response to a match being identified by the comparing the event data with the workflow data, the notification to the target user.

4. The computer-implemented method of claim 1, wherein comparing the event data with the workflow data comprises comparing an issuing user of the event with the active workflow of the user.

5. The computer-implemented method of claim 4, wherein selectively presenting the notification to the target user comprises presenting, in response to a match being identified by the comparing the event data with the workflow data, the notification to the target user.

6. The computer-implemented method of claim 1 further comprising:
generating, based on the event data, a set of event data keywords associated with the event data; and
comparing the set of event data keywords with a set of active workflow keywords associated with the active workflow of the user.

7. The computer-implemented method of claim 6, wherein selectively presenting the notification to the target user comprises presenting, in response to a match being identified by the comparing the set of event data keywords with the set of active workflow keywords, the notification to the target user.

8. The computer-implemented method of claim 1, wherein the event comprises a new task to be completed by the target user.

9. A non-transitory computer-readable storage medium for notifying a target user of an event, the non-transitory computer-readable storage medium comprising computer-executable instructions for:
receiving event data associated with the event;
receiving workflow data associated with an active workflow of the target user;
comparing the event data with the workflow data; and
selectively presenting a notification to the target user based at least in part on the comparing of the event data with the workflow data.

10. The non-transitory computer-readable storage medium of claim 9, wherein comparing the event data with the workflow data comprises comparing a workflow of the event with the active workflow of the user.

11. The non-transitory computer-readable storage medium of claim 10, wherein selectively presenting the notification to the target user comprises presenting, in response to a match being identified by the comparing the event data with the workflow data, the notification to the target user.

12. The non-transitory computer-readable storage medium of claim 9, wherein comparing the event data with the workflow data comprises comparing an issuing user of the event with the active workflow of the user.

13. The non-transitory computer-readable storage medium of claim 12, wherein selectively presenting the notification to the target user comprises presenting, in response to a match being identified by the comparing the event data with the workflow data, the notification to the target user.

14. The non-transitory computer-readable storage medium of claim 9, wherein the non-transitory computer-readable storage medium further comprises computer-executable instructions for:
generating, based on the event data, a set of event data keywords associated with the event data; and
comparing the set of event data keywords with a set of active workflow keywords associated with the active workflow of the user.

15. The non-transitory computer-readable storage medium of claim 14, wherein selectively presenting the notification to the target user comprises presenting, in response to a match being identified by the comparing the set of event data keywords with the set of active workflow keywords, the notification to the target user.

16. The non-transitory computer-readable storage medium of claim 9, wherein the event comprises a new task to be completed by the target user.

17. An apparatus for notifying a target user of an event, the apparatus comprising:
a memory comprising computer-executable instructions that, when executed, cause a processor to:
receive event data associated with the event;
receive workflow data associated with an active workflow of the target user;
compare the event data with the workflow data; and
selectively present a notification to the target user based at least in part on the comparing of the event data with the workflow data; and
a computer processor operable to execute the instructions stored in the memory.

18. The apparatus of claim 17, wherein comparing the event data with the workflow data comprises comparing a workflow of the event with the active workflow of the user.

19. The apparatus of claim 18, wherein selectively presenting the notification to the target user comprises presenting, in response to a match being identified by the comparing the event data with the workflow data, the notification to the target user.

20. The apparatus of claim 17, wherein comparing the event data with the workflow data comprises comparing an issuing user of the event with the active workflow of the user.

21. The apparatus of claim 20, wherein selectively presenting the notification to the target user comprises presenting, in response to a match being identified by the comparing the event data with the workflow data, the notification to the target user.

22. The apparatus of claim 17, wherein the memory further comprises computer-executable instructions that, when executed, cause he processor to:
generate, based on the event data, a set of event data keywords associated with the event data; and
compare the set of event data keywords with a set of active workflow keywords associated with the active workflow of the user.

23. The apparatus of claim 22, wherein selectively presenting the notification to the target user comprises presenting, in response to a match being identified by the comparing the set of event data keywords with the set of active workflow keywords, the notification to the target user.

24. The apparatus of claim 17, wherein the event comprises a new task to be completed by the target user.
